(19) United States
(12) Patent Application Publication
(10) Pub. No.: US 2025/0383609 A1
(43) Pub. Date: Dec. 18, 2025

(54) METHOD AND SYSTEM FOR ANALYZING WAFERS

(71) Applicant: SAMSUNG ELECTRONICS CO., LTD., Suwon-si (KR)

(72) Inventors: Minkyu Kim, Suwon si (KR); Qhwan Kim, Suwon si (KR); Seungju Kim, Suwon si (KR); Ami Ma, Suwon si (KR); Chohwan Oh, Suwon si (KR); Kyubaik Chang, Suwon si (KR); Jaehoon Jeong, Suwon si (KR); Wanju Cho, Suwon Si (KR); Hyeonjin Joo, Suwon si (KR)

(73) Assignee: SAMSUNG ELECTRONICS CO., LTD., Suwon-si (KR)

(21) Appl. No.: 19/027,951

(22) Filed: Jan. 17, 2025

(30) Foreign Application Priority Data
Jun. 14, 2024 (KR) 10-2024-0077760

(51) Int. Cl. G03F 7/00

(52) U.S. Cl. CPC G03F 7/70633; G03F 7/70625; G03F 7/706833; G03F 7/706837

(57) ABSTRACT

A method for analyzing a wafer includes acquiring first measurement data for a first wafer and second measurement data for a second wafer, generating normalization data including first normalization data and second normalization data obtained by scaling the first measurement data and the second measurement data, respectively, separating each of the first normalization data and the second normalization data into at least one component to generate component data including first component data and second component data, and outputting a similarity of the first wafer and the second wafer calculated based on the component data.

### CROSS-REFERENCE TO RELATED APPLICATION

This application is based on and claims priority under 35 USC § 119 to Korean Patent Application No. 10-2024-0077760, filed on Jun. 14, 2024, in the Korean Intellectual Property Office, the disclosure of which is incorporated by reference herein in its entirety.

### BACKGROUND

### 1. Field

The disclosure relates to a method and system for analyzing wafers, and more particularly, to a method for measuring similarity between wafers.

### 2. Description of Related Art

As semiconductor technology has become more advanced and the semiconductor manufacturing processes have become more complex, the need for a technology to accurately set or predict a manufacturing process has also increased. In a related art process, analysis of wafer map patterns is used in a manufacturing process to determine or improve model consistency, and when similarity is secured by comparing wafer maps, the wafer maps may be determined as appropriate models. However, when determining the similarity between wafers, users (e.g., manufacturing engineers) may manually or qualitatively determine the similarity, which has limitations in that a turnaround time (TAT) increases excessively and a full evaluation is impossible. Furthermore, absence of objective and quantified standards may be fatal to model design, such as failing to distinguish between fine differences or causing misjudgments, and thus, may be inappropriate for securing high consistency.

### SUMMARY

One or more aspects of the disclosure provide an objective and quantitative wafer comparison analysis method and system based on similarity measurement.

According to an aspect of the disclosure, there is provided a method of analyzing a wafer including: obtaining first measurement data corresponding to a first wafer and second measurement data corresponding to a second wafer; generating normalization data including first normalization data obtained by scaling the first measurement data and second normalization data obtained by scaling the second measurement data; separating each of the first normalization data and the second normalization data into at least one component to generate component data including first component data corresponding to the first wafer and second component data corresponding to the second wafer; and outputting a similarity of the first wafer and the second wafer based on the component data.

According to another aspect of the disclosure, there is provided a computer system for analyzing a wafer, the computer system including: one or more processors; and one or more memories electrically connected to the one or more processors and configured to store at least one instruction, wherein, when executed by the at least one processor, the at least one instruction is configured to control the device to implement: an input module configured to obtain first measurement data corresponding to a first wafer and second measurement data corresponding to a second wafer; a normalization module configured to generate normalization data including first normalization data obtained by scaling of the first measurement data and second normalization data obtained by scaling the second measurement data; a separation module configured to separate each of the first normalization data and the second normalization data into at least one component to generate component data including first component data corresponding to the first wafer and second component data corresponding to the second wafer; and a similarity module configured to obtain a similarity of the first wafer and the second wafer based on the component data.

According to an aspect of the disclosure, there is provided a non-transitory computer-readable storage medium having stored thereon instructions, which when executed by at least one processor, cause the at least one processor to perform a method of analyzing a wafer including: obtaining first measurement data corresponding to a first wafer and second measurement data corresponding to a second wafer; generating normalization data including first normalization data obtained by scaling the first measurement data and second normalization data obtained by scaling the second measurement data; separating each of the first normalization data and the second normalization data into at least one component to generate component data including first component data corresponding to the first wafer and second component data corresponding to the second wafer; and outputting a similarity of the first wafer and the second wafer based on the component data.

### BRIEF DESCRIPTION OF DRAWINGS

Embodiments will be more clearly understood from the following detailed description taken in conjunction with the accompanying drawings in which:

FIG. 1 is a block diagram schematically illustrating a wafer analysis system according to an embodiment;

FIG. 2 is a flowchart illustrating a wafer analysis method according to an embodiment;

FIGS. 3A to 3C are diagrams illustrating measurement data according to an embodiment;

FIG. 4 is a flowchart illustrating normalization according to an embodiment;

FIG. 5 is a diagram illustrating an example of the normalization according to FIG. 4;

FIG. 6 is a flowchart illustrating component separation according to an embodiment;

FIG. 7 is a diagram illustrating an example of the component separation according to FIG. 6;

FIG. 8 is a flowchart illustrating similarity calculation according to an embodiment;

FIG. 9 is a diagram illustrating an example of the similarity calculation of FIG. 8;

FIG. 10 is a flowchart illustrating a similarity calculation according to an embodiment;

FIG. 11 is a diagram illustrating an example of wafer analysis according to an embodiment;

FIG. 12 is a diagram illustrating a process change detection according to an embodiment;

FIG. 13 is a block diagram illustrating a wafer analysis system according to an embodiment; and

FIG. 14 is a block diagram illustrating a computer system according to an embodiment.

### DETAILED DESCRIPTION

Hereinafter, embodiments are described in detail with reference to the accompanying drawings. As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

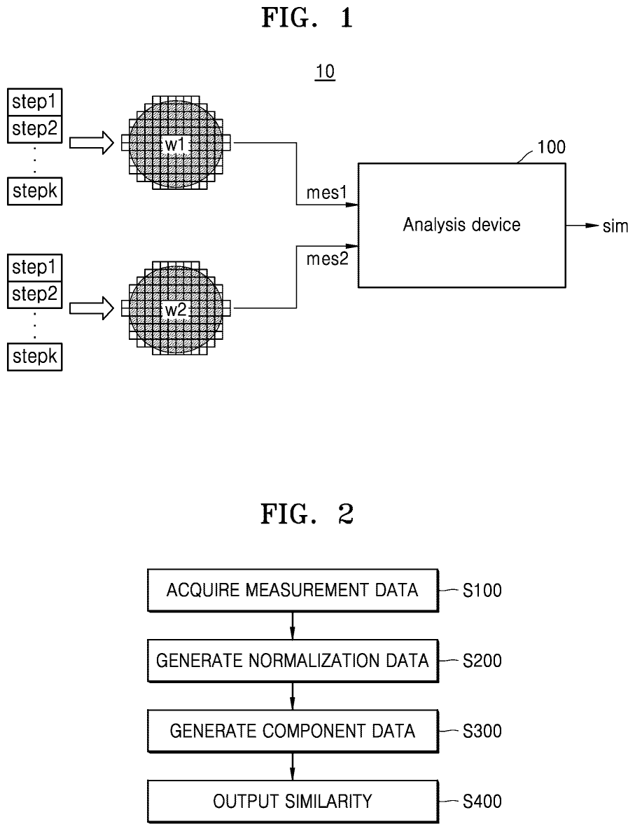

FIG. 1 is a block diagram schematically illustrating a wafer analysis system 10 according to an embodiment.

Referring to FIG. 1, the wafer analysis system 10 may include an analysis device 100. The wafer analysis system 10 may be implemented in various systems that require analysis of a plurality of wafers. In some embodiments, the wafer analysis system 10 may be implemented in a simulation system for simulating a semiconductor process or may be implemented in a test system for testing a semiconductor process. For example, the wafer analysis system 10 may be implemented in an electrical die sorting (EDS) system (or an EDS device). However, the wafer analysis system 10 is not limited thereto, and as such, according to another embodiment, the wafer analysis system 10 may be implemented independently as a separate system for analyzing wafers. In some example cases, systems and/or devices may be referred to as tools. For example, the wafer analysis system 10 may be referred to as the wafer analysis tool 10 and the analysis device 100 may be referred to as the analysis tool 100.

According to an embodiment, a first wafer w1 and a second wafer w2 may be formed by performing certain processes. For example, the certain processes may be predetermined or predefined processes. For example, the first wafer w1 may be formed by performing a first process operation (operationl) to a k-th process operation (operationk) (that is, the first wafer w1 may be a wafer corresponding to the first process operation to the k-th process operation). Similarly, the second wafer w2 may be formed by performing the same processes (e.g., the first process operation to the k-th process operation) as the first wafer w1. The first process operation may be referred to as a first process and the k-th process operation may also be referred to as a k-th process. However, the disclosure is not limited thereto, and as such, according to another embodiment, the processes for making the first wafer and the second wafer may include different process operations or an order of the process operations may be different.

In some embodiments, at least one of the first to k-th processes corresponding to the second wafer w2 may be a process having process conditions partially changed with respect to the first to k-th processes corresponding to the first wafer w1. For example, the k-th process of the first wafer w1 and the second wafer w2 may be a photo process, but the conditions of the photo process of the first wafer w1 may be different from the conditions of the photo process of the second wafer w2. For example, the time of exposure to a light source may be different. In an embodiment, in order to determine more suitable process conditions and/or process models, the same processes as those for the first wafer w1 may be performed on the second wafer w2 as described above, but a condition of at least one process among a plurality of processes corresponding to the second wafer w2 may be changed on purpose. The first wafer w1 may be referred to as a reference wafer, and the second wafer w2 may be referred to as a comparison wafer, target wafer, or test wafer.

According to an embodiment, first measurement data mes1 may be data acquired by performing a measurement operation on the first wafer w1, and the second measurement data mes2 may be data acquired by performing a measurement or operation on the second wafer w2. In an embodiment, the first measurement data mes1 and the second measurement data mes2 may include information on whether each of a plurality of chips included in each wafer is defective. For example, the first measurement data mes1 and the second measurement data mes2 may include information for identifying or detecting whether any of the plurality of chips included in each wafer is defective. In an embodiment, the first measurement data mes1 and the second measurement data mes2 may include information on a structure value of each wafer. For example, the first measurement data mes1 and the second measurement data mes2 may include information on the heights of patterns formed on each wafer. A pattern may refer to a conductive material formed inside a chip to provide signals or power to transistors included in the chip.

However, the information included in the measurement data is not limited thereto and may be configured in various manners. The first measurement data mes1 and the second measurement data mes2 may include various information for analyzing the first wafer w1 and the second wafer w2. In an embodiment, the first measurement data mes1 and the second measurement data mes2 may include information related to electrical characteristics of the first wafer w1 and the second wafer w2. For example, the first measurement data mes1 and the second measurement data mes2 may include, but is not limited to, leakage current values or timing information measured through an EDS test for the first wafer w1 and the second wafer w2. For example, the first measurement data mes1 and the second measurement data mes2 may be attributes, characteristics, or information of the wafer itself, which are used to determine the degree to which the first wafer w1 and the second wafer w2 are similar.

The analysis device 100 may receive first measurement data mes1 and second measurement data mes2 as input data. Based on the first measurement data mes1 and the second measurement data mes2, the analysis device 100 may determine similarity between the first wafer w1 and the second wafer w2. The analysis device 100 may obtain a similarity sim that numerically expresses a degree (or a level) of similarly between the first wafer w1 and the second wafer w2. For example, the similarity sim may be a similarity value or a similarly amount. The analysis device 100 may calculate and output a similarity sim that numerically expresses the degree to which the first wafer w1 and the second wafer w2 are similar.

As a result, the wafer analysis system 10 (or the analysis device 100) according to an embodiment may quantify the similarity between wafers and provide the same. For example, the wafer analysis system may obtain a score (or a numerical value) indicating a level (or an amount) of similarly between the first wafer w1 and the second wafer w2. That is, unlike a user (or an engineer, etc.) directly determining the similarity between wafers through a wafer map, etc., the wafer analysis system 10 (or the analysis device 100) according to an embodiment presents the degree to which wafers are similar in specific numbers, thereby presenting more objective judgment criteria and performing more specific and sophisticated comparative analysis.

FIG. 2 is a flowchart illustrating a wafer analysis method according to an embodiment.

Referring to FIGS. 1 and 2, the analysis device 100 may obtain a similarity value indicating the degree to which the first wafer w1 and the second wafer w2 are similar.

According to an embodiment, in operation S100, the wafer analysis method may include acquiring measurement data. For example, the analysis device 100 may acquire measurement data. For example, the analysis device 100 may receive the first measurement data mes1 and the second measurement data mes2. The first measurement data is based on measuring the first wafer w1, and the second measurement data mes2 is based on measuring the second wafer w2. In an embodiment, the first measurement data mes1 may include data indicating heights of patterns formed on the first wafer w1 and the second measurement data mes2 may include data indicating heights of patterns formed on the second wafer w2. However, the method by which the analysis device 100 acquires the measurement data is not limited thereto and may be implemented in various ways. For example, instead of directly receiving the measurement data from a measurement result, the analysis device 100 may receive raw data corresponding to the wafer and perform a measurement operation on the raw data to acquire the measurement data. For example, the raw data may be image data obtained from capturing an image of the wafer. For example, the method may include obtaining (or capturing) the image data of the wafer by a camera or a sensor. However, the disclosure is not limited thereto, and as such, the raw data may be obtained in another manner.

According to an embodiment, in operation S200, the wafer analysis method may include generating normalization data based on the measurement data. For example, the analysis device 100 may generate normalization data based on the measurement data. For example, the analysis device 100 may normalize two pieces of measurement data in order to compare the measurement data. According to an embodiment, the analysis device 100 may normalize each of the first measurement data mes1 and the second measurement data mes2. For example, the analysis device 100 may normalize the first measurement data mes1 to generate first normalization data and normalize the second measurement data mes2 to generate second normalization data. For example, the first normalization data may be obtained by normalizing the first measurement data mes1 and the second normalization data obtained by normalizing the second measurement data mes2.

According to an embodiment, in operation S300, the wafer analysis method may include separating the normalization data into at least one component to generate component data. For example, the analysis device 100 may separate the normalization data into at least one component to generate component data. The analysis device 100 may separate the first normalization data and the second normalization data to generate component data corresponding to each of the first and second wafers w1 and w2. For example, the analysis device 100 may separate the first normalization data to generate component data corresponding to the first wafer w1 and separate the second normalization data to generate component data corresponding to the second wafer w2.

In some embodiments, the analysis device 100 may separate the normalization data into a radial components. For example, the analysis device 100 may obtain the radial components by extracting the radial component from the normalization data. For example, the analysis device 100 may separate data representing the height of patterns according to a distance (i.e., a radius of a circle) based on the center of the wafer from the normalization data.

In some embodiments, the analysis device 100 may separate the normalization data into a linear component. For example, the analysis device 100 may obtain the radial components by extracting the linear component from the normalization data. For example, the analysis device 100 may separate data representing the height of the patterns according to a straight line distance based on a certain point on the wafer from the normalization data.

In some embodiments, the analysis device 100 may separate a residual component excluding the radial component and the linear component from the normalization data.

However, the disclosure is not limited to the component separation of the wafer analysis method illustrated in operation S300. As such, according to another embodiment the component data may be obtained in various ways. That is, without being limited to the radial component and/or linear component, the components can be separated into various structural components, or the component separation can be based on various techniques.

According to an embodiment, in operation S400, the wafer analysis method may include obtaining a similarity based on the separated component data. For example, the analysis device 100 may calculate a similarity based on the separated component data and output the same. In some embodiments, the analysis device 100 may calculate a similarity for each component and output a component similarity for each component. For example, the analysis device 100 may calculate a similarity in the radial component of the first wafer w1 and the second wafer w2, or may calculate a similarity in the linear component of the first wafer w1 and the second wafer w2. In some embodiments, the analysis device 100 may calculate and output a comprehensive similarity. For example, the analysis device 100 may calculate a comprehensive similarity of the first wafer w1 and the second wafer w2.

As a result, the wafer analysis method according to an embodiment does not simply directly compare each wafer or simply compare wafer maps but may perform multidimensional comparison by dividing each wafer into several components and comparing them, thereby performing multidimensional comparison, and thus, the wafers may be compared more specifically and precisely from various angles.

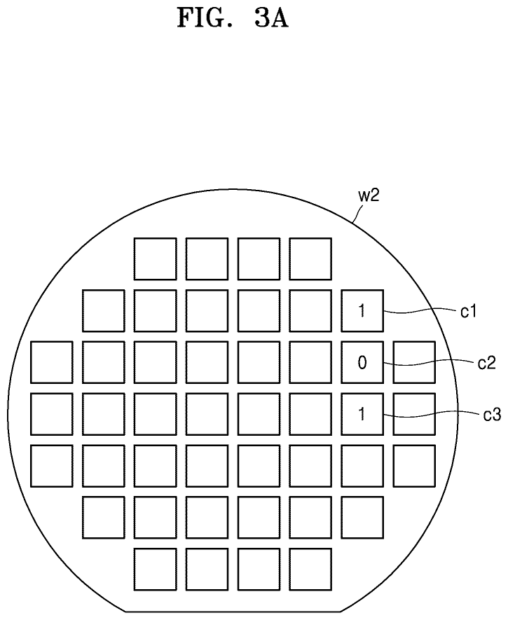

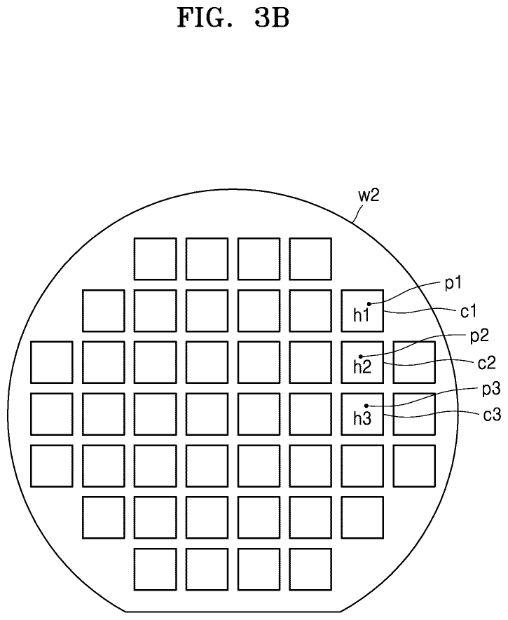

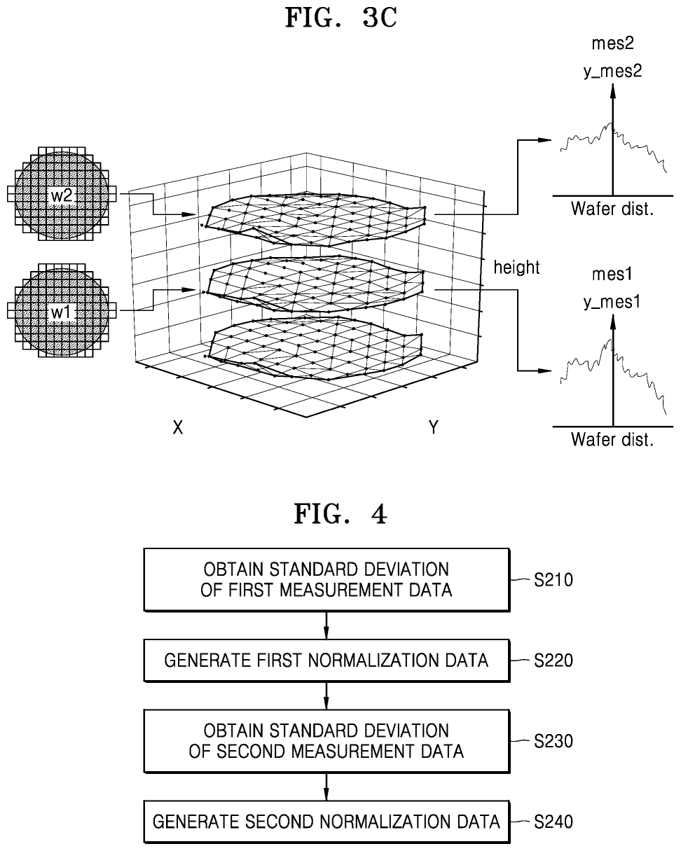

FIGS. 3A to 3C are diagrams illustrating measurement data according to an embodiment.

Referring to FIG. 3A, the analysis device 100 may receive test results for each of the first wafer w1 and the second wafer w2 as measurement data. Hereinafter, for convenience, the description is given based on measurement data for the second wafer w2, which is an object of comparison for the first wafer w1. The second measurement data mes2 corresponding to the second wafer w2 may be data in which a test result (e.g., EDS test result) is mapped to each of the plurality of chips included in the second wafer w2. In some embodiments, the test result may include information related to at least one of the items regarding voltage input/output characteristics, current input/output characteristics, leakage characteristics, functionality characteristics, and timing characteristics.

In some embodiments, the test result may include information (e.g., test result information) indicating whether the corresponding chip is defective after performing a random test on each chip. For example, the test result information may include but is not limited to a blank item (BIN). According to an embodiment, a determination on whether a chip is defective may be based on at least one of the items regarding the voltage input/output characteristics, the current input/output characteristics, the leakage characteristics, the functionality characteristics, and the timing characteristics. For example, as shown in FIG. 3A, a first chip c1 and a third chip c3 included in the second wafer w2 may be determined to be defective based on the test result information. For example, the first chip c1 and the third chip c3 may have a value (“1”) mapped thereto, which indicates defectiveness of the respective chip. Also, as shown in FIG. 3A, a second chip c2 may be determined to be good based on the test result information. For example, the second chip c2 may have a value (“0”) mapped thereto, which indicates good quality of the chip. Although the value “1” is used to indicate bad or defective chips and the value “0” is used to indicate good or non-defective chips, the disclosure is not limited thereto, and as such, other values or other information may be used to indicate whether a chip is defective or not.

Referring to FIG. 3B, the analysis device 100 may receive measurement results for each of the first wafer w1 and the second wafer w2 as measurement data. The second measurement data mes2 corresponding to the second wafer w2 may be data indicating the height of patterns formed on the second wafer w2.

For example, as shown in FIG. 3B, the height of the pattern formed at a point pl on the first chip c1 included in the second wafer w2 may be a first value h1. Similarly, the height of the pattern formed at a point p2 on the second chip c2 may be a second value h2, and the height of the pattern formed at a point p3 on the third chip c3 may be a third value h3.

Referring to FIG. 3C, the measurement data described with reference to FIGS. 3A and 3B may be displayed in a three-dimensional (3D) graph. As shown, the measurement data for the first wafer w1 and the measurement data for the second wafer w2 may be displayed in a 3D graph. For example, the measurement data may indicate the height of the patterns formed on the first wafer w1 and the second wafer w2. In an embodiment, the X-axis and Y-axis of the graph may represent positions on the wafer, and the Z-axis may represent height values of the patterns. In the illustration in FIG. 3C, for convenience of description and understanding, the 3D graph of the measurement data is simply represented as a 2D graph as shown. That is, the X-axis of the first measurement data mes1 and the second measurement data mes2 may refer to the position on the wafer (or a distance on the wafer), and the Y-axis may refer to measurement values (y_mes1 and y_mes2).

As a result, the wafer analysis method according to an embodiment may calculate a similarity even for data (e.g., the height of the pattern) having a continuous value, as well as for discrete data (e.g., whether a chip is defective). Therefore, unlike the method of simply analyzing chips based on defects, the wafer analysis method according to an embodiment may perform comparative analysis on continuous values, thereby providing more precise and consistent comparison results.

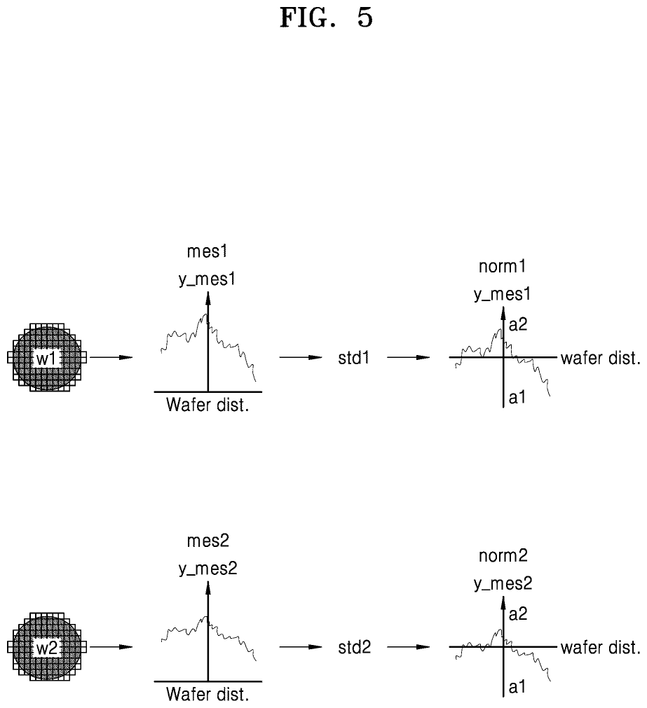

FIG. 4 is a flowchart illustrating a normalization method according to an embodiment. FIG. 5 is a diagram illustrating an example of the normalization method according to FIG. 4.

Referring to FIGS. 2, 4, and 5, the analysis device 100 may perform normalization through a standard deviation of the measurement data. In the drawings of the disclosure, for convenience of explanation, the measurement data is selected as data representing the height of the patterns. However, the disclosure is not limited thereto.

In operation S210, the method may include obtaining a first standard deviation std1 of the received first measurement data mes1. For example, the analysis device 100 may calculate a standard deviation std1 of the received first measurement data mes1. For example, as shown in FIG. 5, the first measurement data mes1 corresponding to the first wafer w1 may be data indicating the height y_mes1 of patterns according to the distance on the first wafer w1. The analysis device 100 may calculate the standard deviation std1 based on a distribution of the height y_mes1 of the patterns.

In operation S220, the method may include generating first normalization data based on the first standard deviation sd1. For example, the analysis device 100 may generate first normalization data norm1 by performing scaling based on the standard deviation std1. The analysis device 100 may distribute the pattern height y_mes1 value within a certain range (e.g., from a first boundary value a1 to a second boundary value a2) through normalization.

In operation S230, the method may include obtaining a second standard deviation std2 of the received second measurement data mes2. For example, the analysis device 100 may calculate a standard deviation std2 of the second measurement data mes2.

In operation S240, the method may include generating second normalization data based on the second standard deviation std2. For example, the analysis device 100 may generate the second normalization data norm2 based on the standard deviation std2.

For example, the second wafer w2 may have different measurement data as the conditions of some of the plurality of processes corresponding to the first wafer w1 change, and in the wafer analysis method according to an embodiment, by correcting the distribution according to the change in process conditions as described above through normalization based on scaling of the measurement data, a more consistent comparison may be performed.

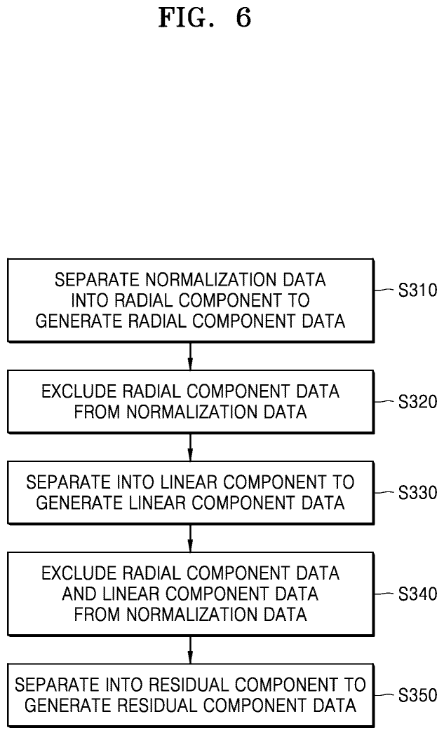

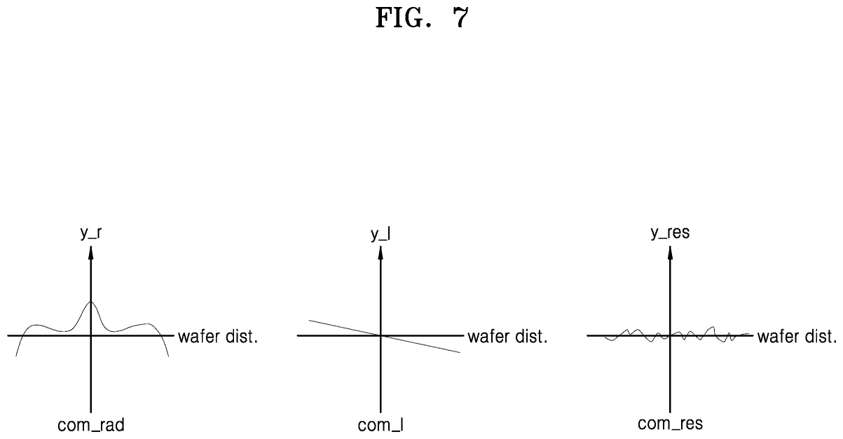

FIG. 6 is a flowchart illustrating a component separation method according to an embodiment. FIG. 7 is a diagram illustrating an example of the component separation method according to FIG. 6.

Referring to FIGS. 2, 6, and 7, the analysis device 100 may separate normalization data into a plurality of components to generate component data. In some embodiments, the analysis device 100 may separate normalization data into radial and linear components.

In operation S310, the method may include separating the normalization data into a radial component to generate radial component data. For example, the analysis device 100 may separate the normalization data into a radial component to generate radial component data com_rad. The analysis device 100 may extract the height of patterns according to distance based on the center of the wafer to generate the radial component data com_rad. For example, the analysis device 100 may separate a height y_r according to the radial component from the height distribution of the patterns and generate the height y_r as radial component data com_rad. Because the radial component represents the distance based on the center of the wafer, the radial component may have symmetry as shown in FIG. 7.

According to an embodiment, in operation S320, the method may include excluding the radial component data from the normalization data, and in operation S330, the method may include separating the normalization data into linear components to generate linear component data. In operations S320 and S330, the analysis device 100 may separate the normalization data into linear components to generate linear component data com_1. In some embodiments, in order to extract the linear component more clearly, the analysis device 100 may separate the linear component after excluding the radial component data com_rad generated in operation S310 from the existing normalization data. In other words, the analysis device 100 may subtract the height y_r according to the radial component from the height distribution of the patterns, then separate a height y_1 according to the linear component from the remaining data, and generate the same as linear component data com_1. However, the disclosure is not limited thereto, and as such, according to an embodiment, operation S320 may be omitted. As such, according to an embodiment, the method may include separating the linear component without excluding the radial component data generated from the existing normalization data.

According to an embodiment, in operation S340, the method may include excluding the radial component data and linear component data from the normalization data, and in operation S340, the method may include separating the normalization data into residual component to generate residual component data. For example, in operations S340 and S350, the analysis device 100 may separate the normalization data into several components and then generate a residual component, which is remaining data, as residual component data com_res. In an embodiment, when all the heights according to the radial component and linear component as described above are excluded from the normalization data, a height y_res according to the residual component may remain, and the analysis device 100 may generate the height y_res as residual component data com_res. However, the disclosure is not limited thereto, and as such, according to an embodiment, operation S340 may be omitted. For example, the method may include separating the linear component without excluding the radial component data and the linear component data generated from the existing normalization data.

The component separation operation as described above may be performed on each of the first normalization data corresponding to the first wafer w1 and the second normalization data corresponding to the second wafer w2. That is, the wafer analysis method according to an embodiment does not simply compare wafers but provides data obtained by separating each wafer into various components, such as a distribution in the radial pattern and a distribution in the linear pattern, thereby comparing the wafers in multiple dimensions and recognizing which components have a major impact.

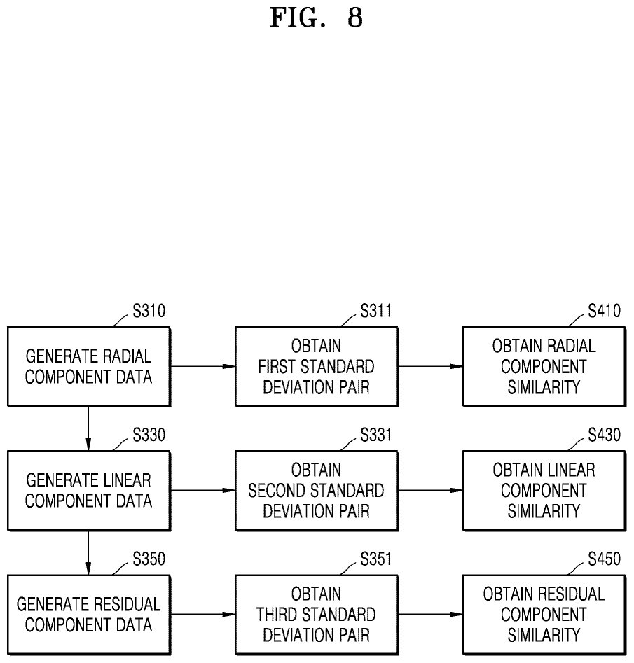

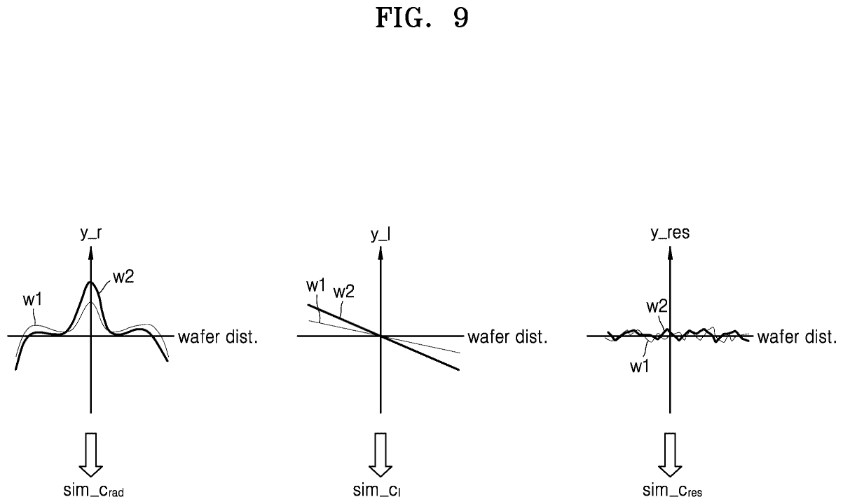

FIG. 8 is a flowchart illustrating similarity calculation according to an embodiment. FIG. 9 is a diagram illustrating an example illustrating the similarity calculation of FIG. 8.

Referring to FIGS. 2, 8, and 9, the analysis device 100 may calculate and output a similarity for each component based on at least one component data separated for each component. In some embodiments, the analysis device 100 may calculate each of a radial component similarity, a linear component similarity, and a residual component similarity.

In operations S310, S330, and S350, the analysis device 100 may generate radial component data com_rad, linear component data com_1, and residual component data com_res for each of the first wafer w1 and the second wafer w2 through component separation as described above.

In operation S311, the analysis device 100 may obtain a first standard deviation pair including a standard deviation for the radial component of the first wafer w1 and a standard deviation for the radial component of the second wafer w2 based on the height y_r according to the radial component for each of the first wafer w1 and the second wafer w2.

For example, as shown in FIG. 9, the height y_r according to the radial component of the first wafer w1 may appear to be different from the height y_r according to the radial component of the second wafer w2, and thus, a first standard deviation pair (STD(y_{1,rad}), STD(y_{2,rad}) may be calculated by calculating each standard deviation.

In operation S410, the analysis device 100 may obtain a radial component similarity sim_c_{rad} corresponding to the radial component data com_rad based on the first standard deviation pair. For example, the analysis device 100 may calculate the radial component similarity sim_c_{rad} corresponding to the radial component based on [Equation 1] below.

$${sim\_c}_{rad} = \frac{1}{N} \sum \vert \frac{{y}_{1 , rad}}{STD ( {y}_{1 , rad} )} - \frac{{y}_{2 , rad}}{STD ( {y}_{2 , rad} )} \vert \qquad [ Equation 1 ]$$

Here, y_{1,rad} is the radial component data (i.e., the height according to the radial component) of the first wafer w1, y_{2,rad} is the radial component data of the second wafer w2, and STD(y) is the standard deviation of y, and N denotes the number of points on the wafer on which measurement was performed.

In operation S331, the analysis device 100 may generate the height y_1 according to the linear component for each of the first wafer w1 and the second wafer w2, and based on the height y_1, the analysis device 100 may calculate a second standard deviation pair including the standard deviation for the linear component of the first wafer w1 and the standard deviation for the linear component of the second wafer w2.

For example, as shown in FIG. 9, the second standard deviation pair (STD(y_{1,l}), STD(y_{2,l})) may be calculated based on the height y_1 according to the linear component of the first wafer w1 and the height y_1 according to the linear component of the second wafer w2.

In operation S430, the analysis device 100 may obtain a linear component similarity sim_c₁ corresponding to the linear component data com_1 based on the second standard deviation pair. For example, the analysis device 100 may calculate the linear component similarity sim_c₁ corresponding to the linear component based on [Equation 2] below.

$${sim\_c}_{l} = \frac{1}{N} \sum \vert \frac{{y}_{1 , l}}{STD ( {y}_{1 , l} )} - \frac{{y}_{2 , l}}{STD ( {y}_{2 , l} )} \vert \qquad [ Equation 2 ]$$

y_{1,l} is linear component data (i.e., height according to the linear component) of the first wafer w1, y_{2,l} is the linear component data of the second wafer w2, STD(y) is the standard of y, and N denotes the number of points on the wafer on which measurement was performed.

Similarly, in operation S351, the analysis device 100 may obtain a height y_res according to the residual component for each of the first wafer w1 and the second wafer w2, and calculare a third standard deviation pair (STD(y_{1,res}), STD(y_{2,res})) In operation S450, the analysis device 100 may calculate a residual component similarity sim_cᵣₑₛ corresponding to the residual component data com_res based on Equation 3 below.

$${sim\_c}_{res} = \frac{1}{N} \sum \vert \frac{{y}_{1 , res}}{STD ( {y}_{1 , res} )} - \frac{{y}_{2 , res}}{STD ( {y}_{2 , res} )} \vert \qquad [ Equation 3 ]$$

Here, y_{1,res} is the residual component data (i.e., the height according to the residual component) of the first wafer w1, y_{2,res} is the residual component data of the second wafer w2, STD(y) is the standard deviation of y, and N denotes the number of points on the wafer in which measurement was performed.

Equation 3 may be summarized as Equation 4 below.

$${sim\_c}_{k} = \frac{1}{N} \sum \vert \frac{{y}_{1 , k}}{STD ( {y}_{1 , k} )} - \frac{{y}_{2 , k}}{STD ( {y}_{2 , k} )} \vert \qquad [ Equation 4 ]$$

Here, sim_cₖ refers to the similarity of each component. k refers to each component, for example, the radial component, the linear component, or the residual component.

That is, in the wafer analysis method according to an embodiment, each wafer is separated into components and a similarity of each component may be separately calculated and output, thereby more precisely performing comparison between the wafers and recognizing in which component a major change has been made in a certain process.

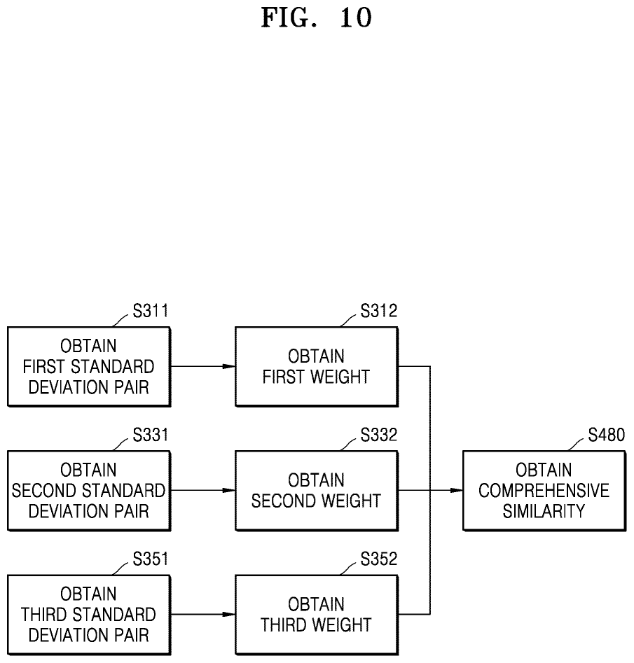

FIG. 10 is a flowchart illustrating similarity calculation according to an embodiment.

Referring to FIGS. 2, 8, 9 and 10, the analysis device 100 may calculate and output a comprehensive similarity between wafers based on a similarity and weight for each component.

As described above, in operations S311, S331, and S351, the analysis device 100 may calculate a first to third standard deviation pairs based on data for each component.

In operation S312, the analysis device 100 may obtain a first weight based on the first standard deviation pair. Similarly, in operations S332 and S352, the analysis device 100 may obtain a second weight and a third weight based on the second standard deviation pair and the third standard deviation pair, respectively.

In some embodiments, the first weight may refer to the degree of dominance of the corresponding radial component data or the similarity sim_c_{rad} of the radial component with respect to the comprehensive similarity of the wafer, that is, the influence of the radial component on the comprehensive similarity. For example, the radial component data of the first wafer w1 and the radial component data of the second wafer w2 may have a distribution as shown in FIG. 9, and the first weight may be determined according to a difference in distribution of the radial component data of the first wafer w1 and the radial component data of the second wafer w2. That is, in some embodiments, the first weight may be calculated based on the first standard deviation pair. The greater difference in the distribution of radial component data of the two wafers and the greater difference of the first standard deviation pair may increase the influence on the comprehensive similarity of the two wafers, and thus, the first weight may increase. In an embodiment, the first weight may be a difference value of the first standard deviation pair. However, the first weight is not limited thereto and may be set based on various operations using the first standard deviation pair.

In some embodiments, the second weight may refer to the degree of dominance of the corresponding linear component data or the influence of the linear component similarity sim_c₁ (i.e., the linear component) on the comprehensive similarity of the two wafers. For example, the linear component data of the first wafer w1 and the linear component data of the second wafer w2 may have a distribution as shown in FIG. 9, and the second weight may be determined according to the difference in distribution of the linear component data of the two wafers. That is, the second weight may be calculated based on the second standard deviation pair. The greater difference between the second standard deviation pair may have greater influence on the similarity of the two wafers and the second weight may increase. The third weight may refer to the influence of the corresponding residual component similarity sim_cᵣₑₛ (i.e., the residual component) on the comprehensive similarity of the two wafers.

In an embodiment, the difference in the distribution of the radial component data of the first wafer w1 and the radial component data of the second wafer w2 may appear more significantly than the difference in the distribution of other component data (e.g., the linear component data and residual component data), and in this case, the radial component is the most dominant component, so the first weight may have the highest value.

In operation S480, the analysis device 100 may calculate the comprehensive similarity based on the radial component similarity sim_c_{rad}, the linear component similarity sim_c₁, and residual component similarity sim_cᵣₑₛ, and the first weight, the second weight, and the third weight corresponding to each component similarity. In some embodiments, the analysis device 100 may calculate the comprehensive similarity based on Equation 5 below.

$$[ Equation 5 ]$$

$$COMPREHENSIVE SIMILARITY = \frac{\begin{matrix}\begin{matrix}RADIAL COMPONENT SIMILARITY \times FIRST WEIGHT + \\ LINEAR COMPONENT SIMILARITY \times SECOND WEIGHT +\end{matrix} \\ RESIDUAL COMPONENT SIMILARITY \times THIRD WEIGHT\end{matrix}}{FIRST WEIGHT \times SECOND WEIGHT \times THIRD WEIGHT}$$

In the wafer analysis method according to an embodiment, each wafer is separated into a plurality of components, the similarity for each component is calculated separately, and further the comprehensive similarity is calculated by considering the weight of the similarity for each component and output, thereby performing more objective and consistent analysis.

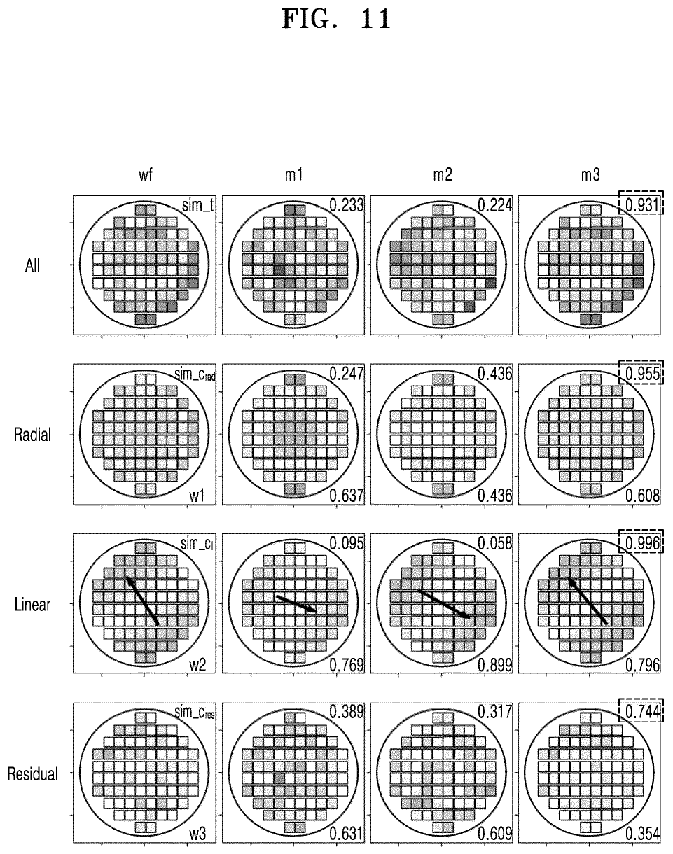

FIG. 11 is a diagram illustrating an example of wafer analysis according to an embodiment.

Referring to FIG. 11, in the wafer analysis method according to an embodiment of the disclosure, a more appropriate model may be selected by comparing actual data and predicted data. In some embodiments, the analysis device 100 may compare the measurement data of the actual wafer wf with the predicted data of a plurality of models m1, m2, and m3, and may separate the predicted data into the components (the radial component, the linear component, and the residual component) and compare them.

As a result of separating the predicted data of the models m1, m2, and m3 into the components and comparing them, the comprehensive similarity sim_t, radial component similarity sim_c_{rad}, linear component similarity sim_c₁, and residual component similarity sim_cᵣₑₛ of the third model m3 may appear significantly higher than the similarities of the other models m1 and m2, and the analysis device 100 may determine the third model m3 as a model with the highest consistency. In addition, because the linear component similarity sim_c₁ has a higher value than other component similarities sim_c_{rad} and sim_cᵣₑₛ, the analysis device 100 may determine that the linear component is the most dominant component.

Unlike simple wafer map comparison or qualitative determination through wafer maps, the wafer analysis method according to an embodiment may perform more objective and highly consistent analysis through comparative analysis based on specific quantification and comparative analysis based on component separation as described above. In addition, the wafer analysis method according to an embodiment may enable comparative analysis of all wafers by automating the comparative analysis and may also reduce time and costs required for analysis.

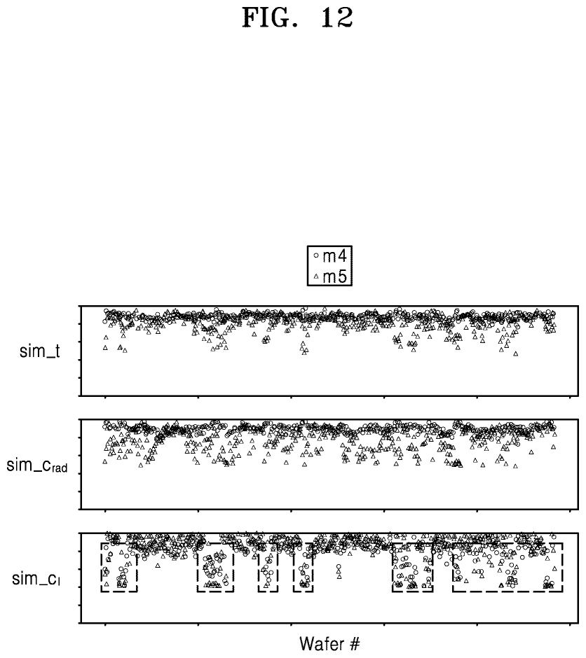

FIG. 12 is a diagram illustrating process change detection according to an embodiment.

Referring to FIGS. 10 and 12, the analysis device 100 may calculate the similarity of each component and the comprehensive similarity and detect in which process a change has occurred based on the calculated similarities.

Referring to FIG. 12, after an initial process setting, the analysis device 100 may analyze the similarity trend of several wafers on which a plurality of same processes have been performed based on a reference wafer (e.g., the first wafer w1). For example, as a result of similarity calculation according to an embodiment based on the structure (result) prediction values of the fourth model m4 and the fifth model m5, a similarity trend as shown may appear. For example, while the comprehensive similarity sim_t and radial component similarity sim_rad of the fourth model m4 are maintained constant at a high value (e.g., a value close to 1), the similarity of the fifth model m5 may appear unstable, and the fourth model m4 may be determined to be a model with higher consistency.

Meanwhile, as shown in FIG. 12, the linear component similarity sim_c₁ may appear unstable in both the fourth model m4, which is determined to have high consistency, and the fifth model m5, which is determined to have low consistency. In detail, as shown in the linear component similarity sim_c₁ graph, both the fourth model m4 and the fifth model m5 may have an unstable similarity distribution in certain wafers (or a certain wafer lot) rather than all wafers. That is, although the fourth model m4 has high consistency, the similarity may appear unstable in certain wafers, like the fifth model m5, which has low consistency. The analysis device 100 may detect certain wafers in which the similarity appears unstable as described above and may determine that a change (e.g., a change in process conditions or instability of the process environment, etc.) has occurred in processes corresponding to the certain wafers (or a certain wafer lot). In addition, the analysis device 100 may classify the change that occurs in the processes as a change that mainly affect linear components.

The wafer analysis method according to an embodiment may detect a process in which a change has occurred by comparing and analyzing the comprehensive similarity sim_t and the component similarities (sim_c_{rad}, sim_c₁).

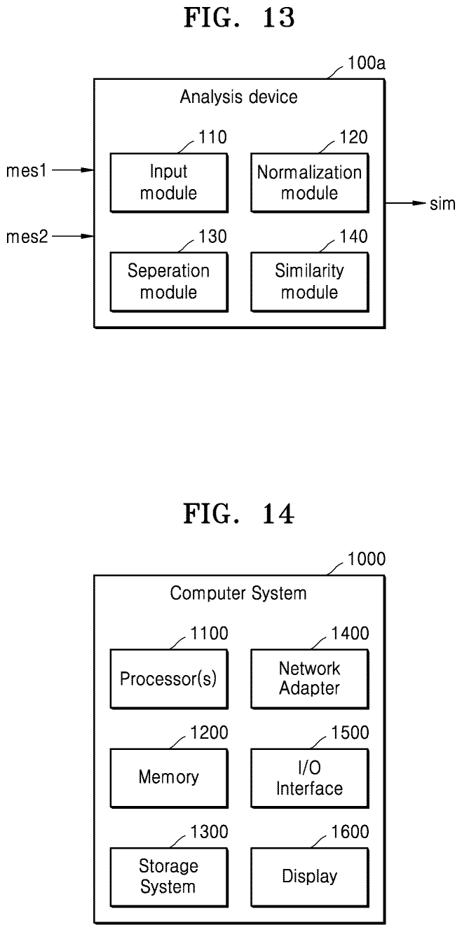

FIG. 13 is a block diagram illustrating a wafer analysis system according to an embodiment.

Referring to FIG. 13, an analysis device 100a of the wafer analysis system according to an embodiment may include an input module 110, a normalization module 120, a separation module 130, and a similarity module 140 to perform the wafer analysis method described with reference to FIGS. 1 to 12. The analysis device 100a may correspond to the analysis device 100 of FIG. 1.

Each of the plurality of modules described in this specification may be referred to as a unit and/or block in which a function is performed, and may, for example, refer to a unit in which a series of computational processes occur. In addition, each of the modules may correspond to hardware, software, or a combination of hardware and software included in the computing system. Hardware may include at least one of programmable components, such as a central processing unit (CPU), digital signal processor (DSP), and graphics processing unit (GPU), reconfigurable components, such as a field programmable gate array (FPGA), and a component providing a fixed function, such as an intellectual property (IP) block. Software may include at least one of a series of instructions executable by a programmable component and code convertible into a series of instructions by a compiler, etc. and may be stored in a non-transitory storage medium.

The input module 110 may receive first measurement data mes1, which is a result of measuring the first wafer, and second measurement data mes2, which is a result of measuring a second wafer. For example, the first wafer may be a reference wafer and the second wafer may be a test wafer. In an embodiment, the first measurement data may be data indicating the height of patterns formed on the reference wafer and the second measurement data may be data indicating the height of patterns formed on the test wafer. According to another embodiment, instead of receiving the measurement data, the input module 110 may receive raw data of the wafer itself and directly perform a measurement operation to acquire measurement data.

The normalization module 120 may scale and normalize the measurement data of the input module 110 to generate normalization data. The normalization module 120 may normalize each of the first measurement data of the reference wafer and the second measurement data of the test wafer and may generate first normalization data obtained by normalizing the first measurement data and second normalization data obtained by normalizing the second measurement data.

The separation module 130 may separate each of the first normalization data and the second normalization data into at least one component to generate first component data and second component data. The separation module 130 may separate the first normalization data into at least one component to generate first component data (e.g., data including radial component data and/or linear component data) corresponding to the reference wafer. Similarly, the separation module 130 may separate the second normalization data into at least one component to generate second component data (e.g., data including radial component data and/or linear component data) corresponding to the test wafer.

The similarity module 140 may obtain a similarity sim based on the separated component data. For example, the similarity module 140 may calculate and output a similarity sim based on the separated component data. In some embodiments, the similarity module 140 may calculate the similarity for each component and output a component similarity. For example, the similarity module 140 may calculate a similarity in the radial component or a similarity in the linear component of each of the reference wafer and the test wafer. In some embodiments, the similarity module 140 may calculate and output an overall comprehensive similarity of the reference wafer and the test wafer.

FIG. 14 is a block diagram illustrating a computer system 1000 according to an embodiment.

In some embodiments, the computer system 1000 of FIG. 14 may perform the wafer analysis method described above with reference to the drawings and may be referred to as a wafer analysis system, a wafer analysis computer system, or the like.

The computer system 1000 may refer to any system including a general-purpose or special-purpose computing system. For example, computer system 1000 may include a personal computer, a server computer, a laptop computer, a home appliance, etc. As shown in FIG. 14, the computer system 1000 may include at least one processor 1100, a memory 1200, a storage system 1300, a network adapter 1400, an input/output (I/O) interface 1500, and a display 1600.

The at least one processor 1100 may execute a program module including computer system executable instructions. The program module may include routines, programs, objects, components, logic, data structures, etc., that perform a certain task or implement a certain abstract data type. The memory 1200 may include a computer system-readable medium in the form of volatile memory, such as random access memory (RAM). The at least one processor 1100 may access the memory 1200 and execute instructions loaded into the memory 1200. The storage system 1300 may non-volatilely store information and, in some embodiments, the storage system 1300 may include at least one program product including a program module configured to perform the wafer analysis method (e.g., normalization, component separation, or similarity calculation) described above with reference to the drawings. As a non-limiting example, the program may include an operating system, at least one application, other program modules, and program data.

The network adapter 1400 may provide access to a local area network (LAN), a wide area network (WAN), and/or a public network (e.g., the Internet). The I/O interface 1500 may provide a communication channel with peripheral devices, such as a keyboard, a pointing device, an audio system, etc. For example, the computer system 1000 may receive measurement data through the I/O interface 1500. The display 1600 may output various information so that the user may check similarity analysis results, etc.

In some embodiments, the method of analyzing a wafer described above with reference to the drawings may be implemented as a computer program product. The computer program product may include a non-transitory computer-readable medium (or storage medium) including computer-readable program instructions for the at least one processor 1100 to perform comparative analysis through a similarity calculation. In some embodiments, the computer program product may include a non-transitory computer-readable medium (or storage medium) including computer-readable program instructions for the at least one processor 1100 to receive measurement data (or generate measurement data through direct measurement) and perform data normalization, component separation, and similarity calculation. As a non-limiting example, the computer-readable instructions include, but are not limited to, assembler instructions, instruction set architecture (ISA) instructions, machine instructions, machine-dependent instructions, microcode, firmware instructions, state setup data, or source code or object code written in at least one programming language.

The computer-readable medium may be any type of medium capable of non-transitorily holding and storing instructions executed by at least one processor 1100 or any instruction-executable device. The computer-readable medium may be, but is not limited to, an electronic storage device, a magnetic storage device, an optical storage device, an electromagnetic storage device, a semiconductor storage device, or any combination thereof. For example, the computer-readable medium may include portable computer diskettes, hard disks, random access memory (RAM), read-only memory (ROM), electrically erasable read only memory (EEPROM), flash memory, static random access memory (SRAM), CD, DVD, memory stick, floppy disk, a mechanically encoded device, such as punch card, or any combination thereof.

While the inventive concept has been particularly shown and described with reference to embodiments thereof. it will be understood that various changes in form and details may be made therein without departing from the spirit and scope of the following claims.

What is claimed is:

1. A method of analyzing a wafer comprising:
obtaining first measurement data corresponding to a first wafer and second measurement data corresponding to a second wafer;
generating normalization data comprising first normalization data obtained by scaling the first measurement data and second normalization data obtained by scaling the second measurement data;
separating each of the first normalization data and the second normalization data into at least one component to generate component data comprising first component data corresponding to the first wafer and second component data corresponding to the second wafer; and
outputting a similarity of the first wafer and the second wafer based on the component data.

2. The method of claim 1, wherein
a first process condition of a first process among a plurality of processes corresponding to the first wafer is different from a second process condition of the first process among the plurality of processes corresponding to the second wafer.

3. The method of claim 1, wherein
the first measurement data comprises first height information corresponding to a first height of patterns formed on the first wafer and the second measurement data comprises second height information corresponding to a second height of patterns formed on the second wafer.

4. The method of claim 1, wherein
each of the first measurement data and the second measurement data comprises at least one of a defect information, a leakage current value information, and timing characteristics information of chips included in the first wafer and the second wafer.

5. The method of claim 1, wherein the outputting of the similarity comprises:
obtaining at least one standard deviation pair corresponding to each of the at least one component based on the first component data and the second component data; and
obtaining a component similarity corresponding to each of the at least one component based on the at least one standard deviation pair.

6. The method of claim 5, wherein
the generating of the component data comprises obtaining a weight corresponding to each of the at least one component based on the at least one standard deviation pair, and
the outputting of the similarity comprises obtaining a comprehensive similarity based on the component similarity and the weight.

7. The method of claim 5, further comprising:
detecting a process in which a process condition has changed, among processes commonly performed on the first wafer and the second wafer based on the component similarity.

8. The method of claim 1, wherein
the generating of the normalization data comprises:
generating the first normalization data based on a first standard deviation of the first measurement data; and
generating the second normalization data based on a second standard deviation of the second measurement data.

9. The method of claim 1, further comprising:
generating the first component data by generating first radial component data by separating the first normalization data into first radial components based on a center of the first wafer; and
generating the second component data by generating second radial component data by separating the second normalization data into second radial components based on a center of the second wafer.

10. The method of claim 9, wherein
the generating of the first component data comprises generating first linear component data by excluding the first radial component data from the first normalization data and separating the first normalization data into first linear components, and
the generating of the second component data comprises generating second linear component data by excluding the second radial component data from the second normalization data and separating the second normalization data into second linear components.

11. The method of claim 10, wherein
the generating of the first component data comprises generating first residual component data corresponding to a first residual component by excluding the first radial component data and the first linear component data from the first normalization data, and
the generating of the second component data comprises generating second residual component data corresponding to a second residual component by excluding the second radial component data and the second linear component data from the second normalization data.

12. The method of claim 11, wherein
the generating of the component data comprises obtaining a first standard deviation pair, a second standard deviation pair, and a third standard deviation pair respectively corresponding to the first component data and the second component data, and
the outputting of the similarity comprises obtaining a component similarity based on Equation 1 below
$${k}_{Component Simiarity} = \frac{1}{N} \sum \vert \frac{{y}_{1 , k}}{STD ( {y}_{1 , k} )} - \frac{{y}_{2 , k}}{STD ( {y}_{2 , k} )} \vert ,$$
$$k = radial , linear , residual ,$$
where N is a number of measurement points on the wafer, y_{1,k} is a measurement value of the first wafer, y_{2,k} is a measurement value of the second wafer, k is a component, and STD(y) is a standard deviation of y.

13. The method of claim 12, wherein
the generating of the component data comprises:
obtaining a first weight, a second weight, and a third weight based on the first standard deviation pair, the second standard deviation pair and the third standard deviation pair, respectively, and
the outputting of the similarity comprises:
obtaining a comprehensive similarity based on Equation 2 below:
$$COMPREHENSIVE SIMILARITY = \frac{\begin{matrix}\begin{matrix}RADIAL COMPONENT SIMILARITY \times FIRST WEIGHT + \\ LINEAR COMPONENT SIMILARITY \times SECOND WEIGHT +\end{matrix} \\ RESIDUAL COMPONENT SIMILARITY \times THIRD WEIGHT\end{matrix}}{FIRST WEIGHT \times SECOND WEIGHT \times THIRD WEIGHT} .$$

14. A computer system for analyzing a wafer, the computer system comprising:
one or more processors; and
one or more memories electrically connected to the one or more processors and configured to store at least one instruction,
wherein, when executed by the one or more processors, the at least one instruction is configured to control the computer system to implement:
an input module configured to obtain first measurement data corresponding to a first wafer and second measurement data corresponding to a second wafer;
a normalization module configured to generate normalization data comprising first normalization data obtained by scaling of the first measurement data and second normalization data obtained by scaling the second measurement data;
a separation module configured to separate each of the first normalization data and the second normalization data into at least one component to generate component data comprising first component data corresponding to the first wafer and second component data corresponding to the second wafer; and
a similarity module configured to obtain a similarity of the first wafer and the second wafer based on the component data.

15. The computer system of claim 14, wherein
the similarity module is further configured to:
obtain a plurality of standard deviations corresponding to each of the at least one component based on the first component data and the second component data; and
obtain a component similarity corresponding to each of the at least one component based on the plurality of standard deviations.

16. The computer system of claim 15, wherein
the separation module is further configured to obtain a weight for each of the at least one component based on the plurality of standard deviations, and
the similarity module is further configured to obtain a comprehensive similarity based on the component similarity and the weight.

17. The computer system of claim 15, wherein
the similarity module is further configured to detect a process in which a process condition is changed, among processes commonly performed on the reference wafer and the test wafer based on the component similarity.

18. The computer system of claim 15, wherein
the separation module is further configured to:
generate first radial component data by separating the first normalization data into first radial components based on a center of the first wafer; and
generate second radial component data by separating the second normalization data into second radial components based on a center of the second wafer.

19. The computer system of claim 18, wherein
the separation module is further configured to:
generate first linear component data by excluding the first radial component data from the first normalization data and separating the first normalization data into first linear components, and
generate second linear component data by excluding the second radial component data from the second normalization data and separating the second normalization data into second linear components.

20. A non-transitory computer-readable storage medium having stored thereon instructions, which when executed by at least one processor, cause the at least one processor to perform a method of analyzing a wafer comprising:
obtaining first measurement data corresponding to a first wafer and second measurement data corresponding to a second wafer;
generating normalization data comprising first normalization data obtained by scaling the first measurement data and second normalization data obtained by scaling the second measurement data;
separating each of the first normalization data and the second normalization data into at least one component to generate component data comprising first component data corresponding to the first wafer and second component data corresponding to the second wafer; and
outputting a similarity of the first wafer and the second wafer based on the component data.
